(19) United States
(12) Patent Application Publication
(10) Pub. No.: US 2005/0274834 A1
(43) Pub. Date: Dec. 15, 2005

(54) Air-sac delay drive-hanging device of paper shredder

(75) Inventor: Simon Huang, SanChung City (TW)

Correspondence Address: DENNISON, SCHULTZ & DOUGHERTY, 612 Crystal Square 4, 1745 Jefferson Davis Highway, Arlington, VA, 22202-3417, US

(73) Assignee: MICHILIN PROSPERITY CO., LTD.

(21) Appl. No.: 10/866,146

(22) Filed: Jun. 14, 2004

(51) Int. Cl. B02C 25/00

(52) U.S. Cl. 241/36; 241/100

(57) ABSTRACT

Disclosed is an air-sac delay drive-hanging device of a paper shredder that is mounted to a stand and arranged at an inner lower side of a paper entry formed on an upper lid of the paper shredder, the delay drive-hanging device including: a micro-switch, a rotating actuator, a press plate and an air-sac assembly, wherein the rotating actuator is supported by a shaft base by means of a biasing shaft, the press plate has a first end engaging with a leaf spring of the micro-switch and a second engaging with a coupling neck at a closed end of the air-sac, such that the first end would activate the leaf spring to turn on the micro-switch and the second end would exert a force inwards to compress the air-sac for rapidly discharging air within the air-sac when the press plate is activated by the rotating actuator, and that time required for the air-sac to recover to a fully inflated state would be extended because air is slowly drawn into the air-sac so as to delay the timing for the leaf spring to disengage from the micro-switch to facilitate in discharging paper shreds jammed between blade wheel shafts by means of continuous driving of the motor of the paper shredder.

### CROSS-REFERENCES TO RELATED APPLICATIONS

Not Applicable

### STATEMENT REGARDING FEDERALLY SPONSORED RESEARCH OR DEVELOPMENT

Not Applicable

### DESCRIPTION

1. Field of Invention

The invention relates to a delay drive-hanging device of a paper shredder, particularly to one using a diaphragm at open end of air-sac that would delay the recovery time by means of the obstruction effect provided by process of drawing air into the air-sac after compressing the air-sac so as to delay the timing for turning off the delay micro-switch and to facilitate in discharging paper shreds jammed between blades by means of continuous driving the motor of the paper shredder.

2. Background of Invention

U.S. Pat. No. 6,308,904 discloses a delay drive-hanging device of a paper shredder. The paper shredder is provided with a linked delay device that maintains continuous driving force within the duration from insertion of paper between blade wheel shafts to termination of shredding operation so as to effectively grip and then strip the paper. The device is provided on the blade wheel shafts; the device drives and connects to a link dial by means of a belt. The link dial has an end that couples to a control cylinder by means of minute friction. A delay trigger for a paper entry dial is provided between a side of a paper entrance and the control cylinder. A micro-switch is connected to a primary circuit. The control cylinder has an end face having a notch that corresponds to and controls a retaining dial of the delay trigger. The control cylinder is provided on another side with a resilient press plate that corresponds to and controls a recovering dial. Further, the delay trigger is provided with a cantilever beam at a location adjacent the micro-switch such that insertion of paper changes orientation of the delay trigger to cause the cantilever beam to contact and to activate the micro-switch; after an end edge of the paper is gripped, the delay trigger is triggered by the retaining dial to recover to its original state, while the end face of the control cylinder urges against the micro-switch such that the micro-switch continues to be activated for a while until the control cylinder completes a full rotation subjecting the cantilever beam to sink in the notch so as to cease the driving force.

Despite the excellent delay effect provided by the above delay drive-hanging device, the increasing number of components results in increasing material cost and assembly cost, which cannot possibly keep up with the highly competitive market. It is thus essential to develop a simplified and effective device to reduce the manufacturing cost in order to reduce the manufacturing cost and to meet the market demand. Thus, it is an important subject to develop an improved delay drive-hanging device that would reduce the manufacturing cost and to optimize the shredder performance.

In addition, the conventional delay drive-hanging device may only be adapted to the so-called AUTO mode where paper is advanced downwards, but not to the so-called REV mode where paper is reversed upwards. The activation of the REV mode usually takes place when the number of sheet fed by the user exceeds the sheet capacity of the paper shredder so as to result in idle running of the motor due to paper jammed between the blade wheel shafts. Because the rotating speed of the motor and the blade wheel shafts has reduced under such an circumstance so as to reduce the rate of discharging paper shreds, the paper shreds jammed between the blade wheel shafts would heavily rely on the delay drive-hanging device to discharge paper shreds to ensure smooth operation in the subsequent paper feeding.

### SUMMARY OF INVENTION

It is a primary objective of this invention to provide an air-sac delay drive-hanging device of paper shredder that would eliminate the complicated structure adopted by the conventional mechanism so as to reduce the number of components, the assembly cost, and the manufacturing cost so as to improve the market competitiveness.

It is another objective of this invention to provide an air-sac delay drive-hanging device of paper shredder, where the delay drive-hanging device is adapted to both AUTO and REV modes, so as to resolve the shortcoming of the conventional mechanism where the delay drive-hanging device is only adapted to the AUTO mode to delay the drive-hanging and to optimize the effect of discharging paper shreds. To achieve the above objectives and to resolve the shortcomings of the prior art, this invention discloses an air-sac delay drive-hanging device of a paper shredder that is mounted to a stand and arranged at an inner lower side of a paper entry formed on an upper lid of the paper shredder. The delay drive-hanging device includes a micro-switch, a rotating actuator, a press plate and an air-sac assembly, wherein the rotating actuator is supported by a shaft base by means of a biasing shaft, the press plate has a first end engaging with a leaf spring of the micro-switch and a second engaging with a coupling neck at a closed end of the air-sac, such that the first end would activate the leaf spring to turn on the micro-switch and the second end would exert a force inwards to compress the air-sac for rapidly discharging air within the air-sac when the press plate is activated by the rotating actuator, and that time required for the air-sac to recover to a fully inflated state would be extended because air is slowly drawn into the air-sac so as to delay the timing for the leaf spring to disengage from the micro-switch to facilitate in discharging paper shreds jammed between blade wheel shafts by means of continuous driving of the motor of the paper shredder.

### BRIEF DESCRIPTION OF THE DRAWINGS

These and other modifications and advantages will become even more apparent from the following detailed description of a preferred embodiment of the invention and from the drawings in which:

FIG. 1 is a schematic drawing illustrating the appearance an air-sac delay drive-hanging device according to this invention.

FIG. 2 is a schematic drawing illustrative a perspective view of an air-sac delay drive-hanging device according to this invention.

FIG. 3 is a cross-sectional view of an air-sac delay drive-hanging device according to this invention.

FIG. 4 is a cross-sectional view taken along lines 4-4 of FIG. 3.

FIG. 5 is a schematic view illustrating the process of paper feeding in an air-sac delay drive-hanging device according to this invention.

FIG. 6 is a schematic view illustrating the end of paper feeding in an air-sac delay drive-hanging device according to this invention.

### DETAILED DESCRIPTION OF THE INVENTION (PREFERRED EMBODIMENTS)

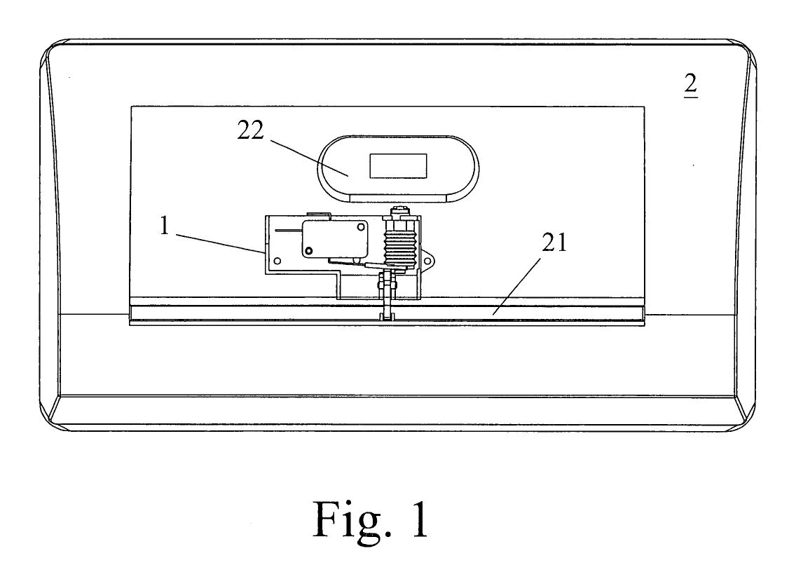

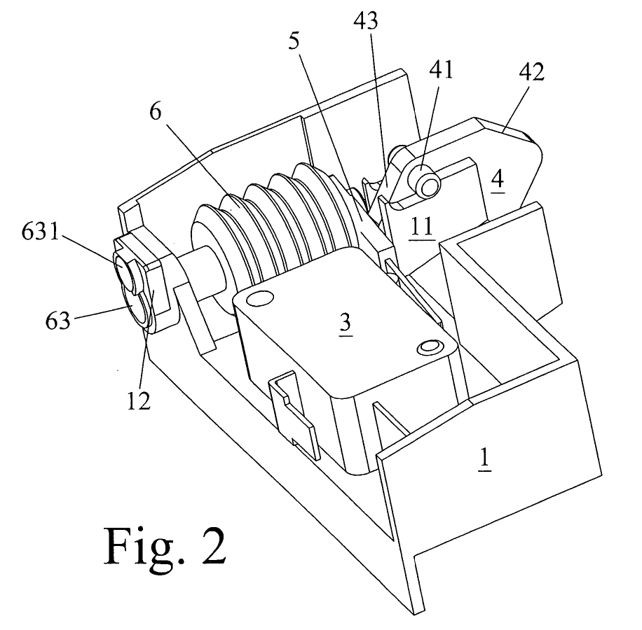

With reference to FIGS. 1 and 2 that illustrate the appearance and perspective view of a schematic drawing illustrating an air-sac delay drive-hanging device according to this invention, respectively, the entire delay drive-hanging device of a paper shredder is mounted to a stand 1 and arranged at a inner lower side of a paper entry 21 formed on an upper lid 2 of the paper shredder. The paper shredder upper lid 2 is provided at front thereof with the conventional control switch that generally includes AUTO, OFF and REV modes.

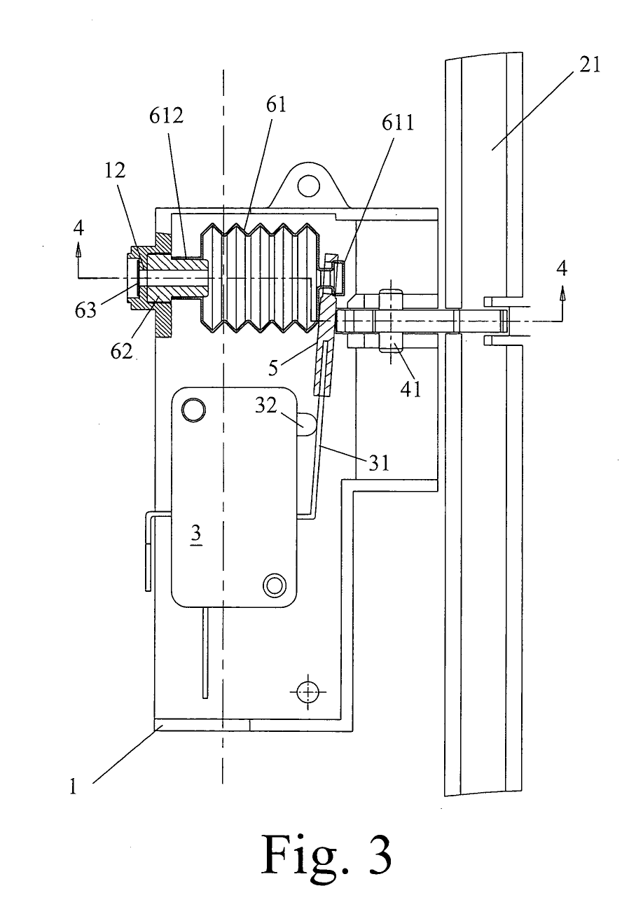

As shown, the delay drive-hanging device includes a micro-switch 3, a rotating actuator 4, a press plate 5 and an air-sac assembly 6. The rotating actuator 4 is supported by a shaft base 11 by means of a biasing shaft 41 and formed at each of a front and a rear side thereof with a triangular protrusion 42, 43. The front protrusion 42 is located beneath the paper entry 21 and the rear protrusion 43 urges against an outer side of the press plate 5. The press plate 5, as shown in the cross-sectional view of FIG. 3, includes a first end engaging with a leaf spring 31 of the micro-switch 3 and a second end engaging with a coupling neck 611 at a closed end of the air-sac 61, such that the first end would activate the leaf spring 31 to turn on the switch 32 and the second end would exert a force inwards to compress the air-sac assembly 6.

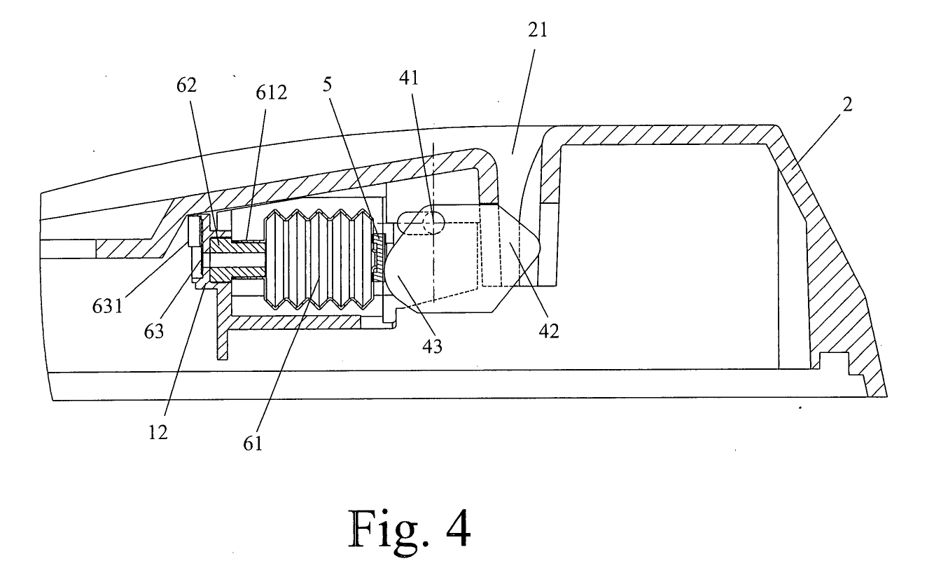

FIG. 4 is a cross-sectional view taken along lines 4-4 of FIG. 3. The air-sac assembly 6 includes: a bellows air-sac 61, a hollow rubber plug 62 and a diaphragm 63. The rubber plug 62 includes a head that is affixed in a through rabbet 12 of an air-sac base, and a body inserting into the coupling neck 612 at an open end of the air-sac 61, such that an air passage communicating the air-sac with ambient air is formed by the hollow rubber plug 62 and through rabbet 12. The diaphragm 63 is provided at an outer side of the through rabbet 12 of the air-sac base by means of a retaining plug 631 and serves to obstruct the air passage.

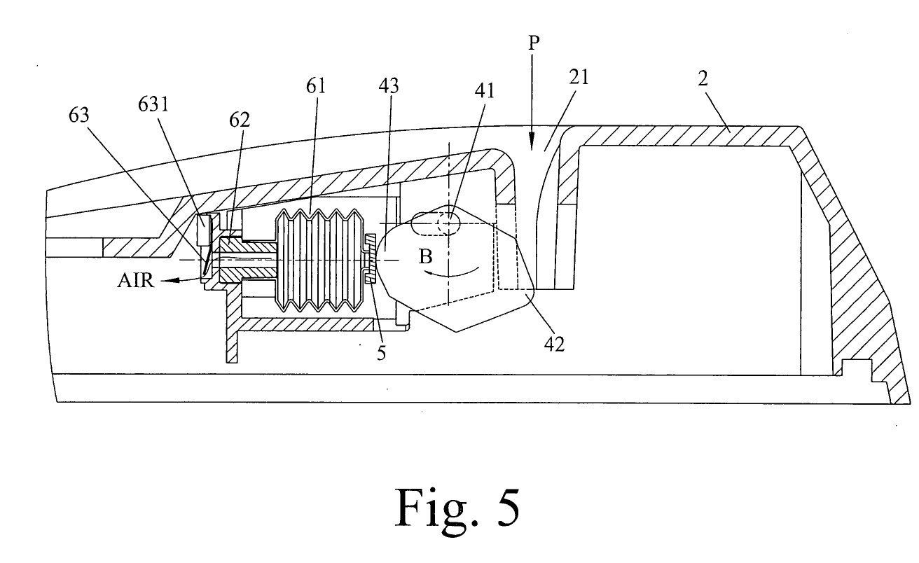

FIG. 5 is a schematic view illustrating the process of paper feeding in an air-sac delay drive-hanging device according to this invention. When a piece of paper is inserted into the paper entry in accordance with an arrow P as shown, and activates the front protrusion 42 of the rotating actuator 4 located at the lower side of the paper entry 21, whereby the rotating actuator 4 would rotate in a counter-clockwise direction as shown by an arrow B about the biasing shaft 41, the specific contour of the rotating actuator 4 would result in a camming effect to exert a force urging the press plate 5 leftwards to compress the air-sac 61, causing air in the air-sac 61 to repel the diaphragm 62 outwards and to be rapidly discharge through the air passage in accordance with an arrow AIR as shown. At this time, the press plate 5 would activate the leaf spring 31 of the micro-switch 32 and cause the paper shredder to drive a motor (not shown) for performing a paper shredding operation.

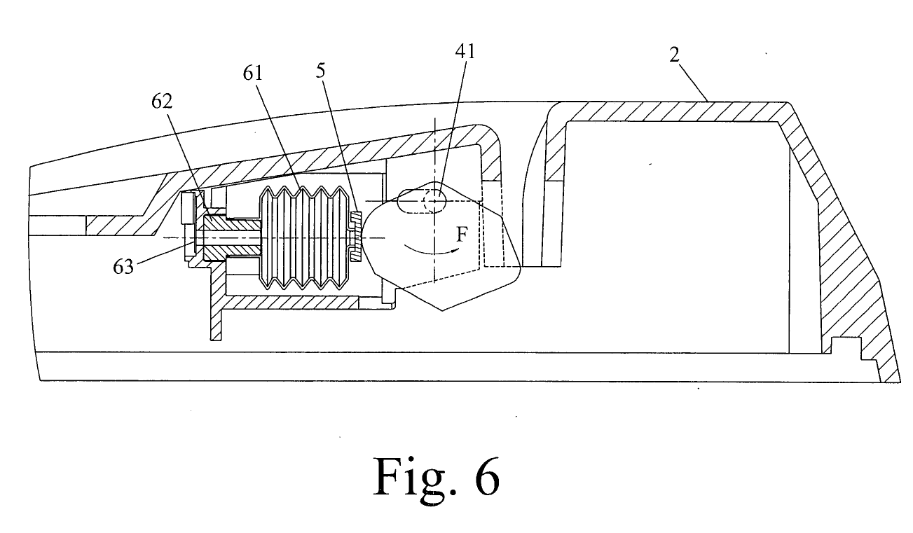

FIG. 6 is a schematic view illustrating the end of paper feeding in an air-sac delay drive-hanging device according to this invention. After the piece of paper has been shredded and fed through the paper shredder, the front protrusion 42 of the rotating actuator 4 is de-activated due to absence of the paper, such that that recovering resilience of the leaf spring 31 of the micro-switch 31 and the recovering force of the compressed air-sac 61 would exert a force rightwards urging the rotating actuator 4 to rotate in a clockwise direction as shown by an arrow F about the biasing shaft 41. Since the diaphragm 63 is provided at the outer side of the through rabbet 12 of the air-sac base and serves to obstruct the air passage, air would be slowly drawn into the air-sac 61, such that time required for the air-sac 61 to recover to a fully inflated state would be extended so as to delay the timing for the leaf spring 31 to disengage from the switch 32. As such, even if the paper to be shredded has been completely fed through the location for activating the front protrusion 42 of the rotating actuator 4, the paper shredder would still continue drive the motor for a short duration to facilitate in discharging paper shreds.

In case paper is jammed during the paper shredding operation and the paper shredder is switched to the REV mode, once the paper is rejected upwards from the paper entry and thus passes through the location that would activate the front protrusion of the rotating actuator, the delay drive-hanging device would cause the paper shredder to drive the motor for a short period as done in the AUTO mode described above for discharging the paper shreds.

The air-sac delay drive-hanging device of this invention eliminates many components adopted by the prior art, and thus significantly reduces the number of components so as to reduce the assembly and manufacturing cost thereby improving the market competitiveness. In addition, the delay drive-hanging device of this invention may be adapted in both AUTO and REV modes so as to resolve the shortcoming that the delay device can only be adapted in AUTO mode as done in the prior art so as to optimize the shredder performance.

This invention is related to a novel creation that makes a breakthrough in the art. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

1. An air-sac delay drive-hanging device of a paper shredder that is mounted to a stand and arranged at an inner lower side of a paper entry formed on an upper lid of the paper shredder, the delay drive-hanging device comprising:
a micro-switch, a rotating actuator, a press plate and an air-sac assembly, wherein the rotating actuator is supported by a shaft base by means of a biasing shaft, the press plate has a first end engaging with a leaf spring of the micro-switch and a second engaging with a coupling neck at a closed end of the air-sac, such that the first end would activate the leaf spring to turn on the switch and the second end would exert a force inwards to compress the air-sac.

2. The air-sac delay drive-hanging device of a paper shredder of claim 1, wherein the rotating actuator supported by the shaft base by means of the biasing shaft is formed at each of a front and a rear side thereof with a triangular protrusion.

3. The air-sac delay drive-hanging device of a paper shredder of claim 2, wherein the front protrusion is located beneath the paper entry and the rear protrusion urges against an outer side of the press plate.

4. The air-sac delay drive-hanging device of a paper shredder of claim 1, wherein the air-sac assembly comprises: a bellows air-sac, a hollow rubber plug and a diaphragm, the rubber plug having a head that is affixed in a through rabbet of an air-sac base, and a body inserting into the coupling neck at an open of the air-sac, such that an air passage communicating the air-sac with ambient air is formed by the hollow rubber plug and through rabbet, the diaphragm being provided at an outer side of the through rabbet of the air-sac base by means of a retaining plug and serving to obstruct the air passage.
